(19) United States
(12) Patent Application Publication
(10) Pub. No.: US 2005/0014877 A1
(43) Pub. Date: Jan. 20, 2005

(54) VOC free latex coalescent systems

(76) Inventor: Gerald Sugerman, Allendale, NJ (US)

Correspondence Address: EDWARDS & ANGELL, LLP, P.O. BOX 55874, BOSTON, MA, 02205, US

(21) Appl. No.: 10/853,516

(22) Filed: May 24, 2004

Related U.S. Application Data
(60) Provisional application No. 60/473,080, filed on May 23, 2003.

(51) Int. Cl. C08L 1/00

(52) U.S. Cl. 524/236; 524/366; 524/386

(57) ABSTRACT

Combinations of essentially nonvolatile, unsaturated ethers and/or esters, and small proportions of low glass transition temperature (Tg) latex reins, as replacements for volatile organic compounds (VOCs) as coalescents and optionally reactive amines (as replacements for conventionally employed volatile amines/ammonia neutralizers, respectively), provides economical, low/no VOC-containing acrylic, styrenic copolymer, polyester, polyurethane and vinyl copolymer latex based coatings, paints, and inks; which outperform their conventional counterparts.

### CROSS-REFERENCE TO RELATED APPLICATIONS

This application claims benefit of U.S. application Ser. No. 60/473,080, filed May 23, 2003, and PCT International Application ______ (filed Apr. 5, 2004, EV438974223) entitled “VOC FREE LATEX COALESCENT SYSTEMS”, which claims benefit of U.S. application Ser. No. 60/460,096, filed Apr. 3, 2003, each of which is incorporated by reference in its entirety.

### BACKGROUND

The usage of combinations of volatile amines as neutralizing agents/stabilizers, and of alcohols, glycols, ketones, and glycol monoethers and monoesters, at levels up to 40% of resin content, by weight, has been employed for more than fifty years to achieve the coalescence of latex solids in acrylic, styrenic copolymer polyvinyl acetate and related copolymer resins based coatings. The volatilization of these conventional neutralizers, and/of coalescing components, after achieving film coalescence is normally required in order inhibit the resultant film's breakdown (reversion) in the presence of humid environments, and to provide acceptable wear and stain resistance to the dried film.

Recent concerns regarding the environmental degradation (predominantly low level atmospheric ozone formation), and the health and fire hazards associated with exposure to volatile organics (VOCs), has led to increasingly strict regulatory limitations on the nature, and proportions of VOCs which may be employed in coatings.

One technique that has been employed in order to comply with said strictures in latex coating applications, is the development of self coalescing latex resins, employing significant proportions of olefinic monomers, (e.g., Airflex 809 Air Products Corp.) which require minimal or no coalescents, but add significantly to production hazards and costs, due to the high pressures which must be employed to solubilize these highly flammable monomers. Alternatively, olefin-acrylate-vinyl co- and/or terpolymers have been blended with more conventional (incompletely compatible) acrylic and/or vinyl polymers and /or copolymers to produce bi/multiphasic self coalescing polymer systems (e.g., Acronal S760-BASF) However, to date, such olefin monomer derived materials have been limited to low Tg film formers, with poor gloss, and poor physical and chemical resistance performance properties. The instant disclosure provides technology which overcomes said deficiencies.

### SUMMARY

This invention relates to the use of low levels of combinations of, unsaturated esters and /or ethers and low glass transition temperature (Tg) latex resins, optionally in combination with non-volatile reactive amines, as (partial or full) replacements for conventionally employed organic solvents as coalescents, and optionally volatile amines/ammonia neutralizers, respectively. Said usage not only effectively reduces emissions and enhances the performance of films produced from said conventional latex resins, but especially when employed in conjunction with certain types of hypersurfactants (cf. Table 3), also often upgrades pigment/extender dispersion, and reduces grind times in particulate containing variants; thus enabling enhanced plant and energy use efficiencies.

One aspect is a composition including (e.g., comprising, essentially consisting of, consisting of ) a combination of essentially nonvolatile, unsaturated esters/ethers/ether-esters, and a low glass transition temperature (Tg) latex resin. The composition can further include a nonvolatile reactive amine; and/or an organometallic. The composition can be that wherein the aforementioned combinations are a coalescent. The composition can be a latex coating, ink or paint.

The composition can be a coalescent that comprises (consists essentially of) the combination of essentially nonvolatile, unsaturated esters/ethers/ether-esters, and a low glass transition temperature (Tg) latex resin. The coalescent can further include (consists essentially of) a nonvolatile reactive amine, and/or an organometallic.

Another aspect is a composition herein, wherein the composition is essentially devoid of conventional surfactants.

Another aspect is a coalescent system for latex resins comprising a combination of essentially nonvolatile, unsaturated esters/ethers/ether-esters, and low Tg latex resins.

Another aspect is any of the compositions herein, wherein the unsaturated esters/ethers/ether-esters comprise one or more hydroxyl functional groups.

Another aspect is a coalescent system for acrylic latex resins, for vinyl, and or vinyl copolymer latex resins, for styrenic copolymer latex resins, for polyurethane latex resins, or polyester latex resins, comprising a combination of essentially nonvolatile, unsaturated esters/ethers/ether-esters, and low Tg latex resin(s), and optionally from 0.2 to about 2 weight % of one or more organometallic based surfactants, and optionally from 0.1 to about 4% of essentially non-volatile reactive amine(s).

Another aspect is a method for coalescing a latex resin comprising combining a latex resin with an essentially nonvolatile unsaturated ester/ether/ether-ester and a low Tg latex resin. The method can further include combining from 0.2 to about 2 weight % of one or more organometallic based surfactants; combining from 0.1 to about 4 weight % of essentially non-volatile reactive amine(s); or combination thereof. The method can be any herein, wherein the latex resin is a vinyl copolymer, a styrenic copolymer, or an acrylic polymer or copolymer.

Another aspect is a method of making any one of a low VOC latex coating, paint, or ink, comprising combining a latex resin with an essentially nonvolatile, unsaturated ester/ether/ether-ester and low Tg latex resin(s). The method can further include combining from 0.2 to about 2 weight % of one or more zirconium based surfactants and/or from 0.1 to about 4 weight % of essentially non-volatile reactive amine(s). The method can be that wherein the latex coating, paint, or ink is essentially devoid of VOCs.

Another aspect is a product made by the process of combining essentially nonvolatile, unsaturated esters/ethers/ether-esters, and low Tg latex resin(s), and optionally from 0.1 to about 2 weight % of one or more organometallic based surfactants, and optionally from 0.1 to about 4% of essentially non-volatile reactive amine(s).

Another aspect is a method of making a low VOC latex coating, useful as floor coating, architectural and/or maintenance coatings, including combining a latex resin with an essentially nonvolatile, unsaturated ester/ether/ether-ester and low Tg latex resin(s).

Another aspect is a method of making a low VOC latex coating, useful as a floor coating, architectural and/or maintenance coatings, comprising combining a latex resin with an essentially nonvolatile, unsaturated ester/ether/ether-ester and low Tg latex resin(s) as a coalescent, wherein the coalescent can further include a nonvolatile reactive amine, and optionally, an organometallic, and/or a polyglycol mono ether, and or polyglycol mono ether ester, preferably a polyglycol mono ether ester having an hydroxyl group alpha or beta to the ester carboxyl.

Another aspect is a low VOC latex coating, useful as a floor coating, architectural and/or maintenance coatings, comprising a latex resin with an essentially nonvolatile, unsaturated ester/ether/ether-ester and low Tg latex resin(s) as a coalescent, wherein the coalescent further comprises a nonvolatile reactive amine, and optionally, an organometallic, and/or a polyglycol mono ether, and or polyglycol mono ether ester, preferably a polyglycol mono ether ester having an hydroxyl group alpha or beta to the ester carboxyl.

Another aspect is a latex coating (e.g., latex resin-based ink, latex resin-based paint) in which conventionally employed volatile amines/ammonia neutralizers, and organic solvents are substantially or fully replaced by a combination of essentially nonvolatile, unsaturated esters/ethers/ether-esters. and low Tg latex resin(s), and optionally from 0.1 to about 2 weight % of one or more metal based surfactants, and optionally from 0.1 to about 4% of essentially non-volatile reactive amine(s).

In other aspects, the composition is a latex coating, ink, or paint herein that is essentially devoid (or completely devoid)of a coalescent material including organic solvent (e.g., VOCs) which is removed or evaporates during processing or curing of the composition and performs as a coalescent material; is a latex coating, ink, or paint herein that is essentially devoid (or completely devoid) of a volatile amine, including e.g., ammonia, or amine neutralizers that perform as a coalescent material. In another aspect, the composition is a latex coating, ink, or paint herein that is essentially devoid (or completely devoid) of volatile amines, including e.g., ammonia, or amine neutralizers.

In an alternate embodiment, the composition of matter comprises a volatile organic compound (“VOC”) free vehicle comprising any of the compositions delineated herein. The term “VOC free”, refers to compositions essentially not formulated with, or not comprising, chemical components that are considered volatile organic compounds as that term is known in the art, and as defined by US EPA Method 24.

Another aspect is a method of making a coalescent system comprising combining essentially nonvolatile, unsaturated esters/ethers/ether-esters, and low Tg latex resin(s), and optionally one or more metal based surfactants (e.g., from 0.1 to about 2 weight %), and optionally essentially non-volatile reactive amine(s) (e.g., from 0.1 to about 4%). The coalescent system can be used for coalescing polymer materials, including for example, latex coating, inks and paints. The method can include making any of the systems delineated herein.

In other aspects, the invention relates to a method of printing comprising application of any of the compositions herein to a print medium. The print medium can be any suitable for print (e.g., paper, glossy, polymer, metal, wood and the like). Printing can be accomplished using a variety of methods, including a press. Flexographic printing is the art or process of printing from a flat elastomeric plate, in which the desired image is achieved by construction of said plate such that selective adhesion of the printing ink to plate occurs in the desired image area(s), followed by contact transfer of said image either directly, or indirectly to a substrate (e.g., paper, plastic, metal). Such applications can be intaglio or off-set, including sheet-fed, cold-web, and heat set web printing.

In other aspects, the invention relates to a method of painting comprising application of any of the compositions herein to a surface. The surface can be any paintable surface (e.g., paper, wood, polymer, metal and the like). The application can be by any standard method, including for example, roller applicator, brush, sprayer, dispersion head and the like).

The details of one or more embodiments of the invention are set forth in the accompanying drawings and the description below. Other features, objects, and advantages of the invention will be apparent from the description and drawings, and from the claims.

### DETAILED DESCRIPTION

A wide variety of low Tg resins may be usefully employed in the practice of this invention. Those most useful are materials having significant solubility (preferably complete solubility at the concentrations employed) in the resin or combination of resins employed as the major film former.

Organometallic compounds are compounds (or complexes) having organic (i.e., carbon and hydrogen containing) functional groups bound (including covalently or through noncovalent binding interactions) to metal atom(s). In one aspect the compounds are those having a metal atom in an oxidation state of (IV). IN another aspect the compounds are organozirconium compounds. Organometallic compounds useful in the compositions and methods herein include, for example, those listed in the tables herein.

The non-volatile reactive amines useful in conjunction with the practice of this invention have vapor pressures below 1 mm Hg at 25 C, contain at least one each basic nitrogen, and at least one carbon to carbon double bond, and/or a transition metal ligand, and contain no more than twelve carbon atoms per basic nitrogen atom. Those more preferable, contain one or more (meth)acryl, N-allyl and/or N-vinyl ligands, and those most preferable have a water solubility exceeding 2% at 25 C. Specific examples of such useful non-volatile reactive amines are given in Table (A). Other embodiments of the invention include those specifically delineated in the tables and examples herein. These examples are intended to be illustrative rather than exhaustive of the scope of useful materials.

TABLE A

(AA) 4,4′ bis N-vinyl pyrrolidone
(AB) N,N,N′-tris(2-butenyl),ethylene diamine
(AC) N′,methyl-1,3-propylene diamine mono 2-propenamide
(AD) (N,2-propenyl)bis(2-hydroxy)propyl amine
(AE) N,2-propenyl,N′-(2-hydroxy)ethyl,hexamethylene triamine
(AF) 4-(N,3-hydroxypropyl,N-vinyl)2-amino ethyl 2-butenoate
(AF) 2-[N,(2-oxa-cyclopentadienyl)]amino acetic acid ethyl ester
(AG) 4-(N,N bis vinylamino)1,3-pentanediol
(AH) tetraethylene glycol mono 3-(N,ethyl)amino,2-(methyl)2-
propenoate
(AJ) N,N-divinyl glutamic acid 2-propenyl ester
(AK) 6-(N,N bis vinyl)hexanoic acid ethyl ester

The preferred types of unsaturated esters/ethers/ether-esters useful in conjunction with the practice of this invention are those having vapor pressures below 0.1 mm Hg at 25 C, which are capable of, air initiated oxidative oligomerization/polymerization derived, non-reversible bonding, under normal latex application conditions, to film component(s) and /or to substrate, in order to maximize coating properties, via crosslinking the resulting latex thereby minimizing its (post film formation) environmental sensitivity. Examples of such unsaturated esters and ethers as are useful in the practice of the instant invention are provided in Table B. These examples are intended to be illustrative rather than exhaustive of the scope of useful materials.

TABLE B
(BA) trimethylol propane bis(2-methyl)-2-propenoate ester
(BB) sorbitan tetrakis 2-butenoate ester
(BC) bis penta erethyritol 2-propenolato,tris 2-propenoate ester
(BD) hexanoic acid 6-hydroxy,(2-propenoato)ethyl ester
(BE) citric acid tris isodecenyl ester
(BF) malic acid bis cinnamyl ester
(BG) 2,2-bis furoic acid 2-propenyl ester
(BH) 1,2,3-propane triol 1,3-bis vinyl ether,2-phenyl carboxylate ester
(BJ) tris 2-butene diol mono(methyl)glutarate ester
(BK) ethoxylated(4)bis phenol A mono 2-propenoate ester

The surfactants most useful in conjunction with the practice of this invention are those having vapor pressures below 0.1 mm Hg at 25 C, which are capable of non-reversible bonding, under normal processing conditions, to film component(s) and /or substrate in order to maximize coating properties, while minimizing post film formation environmental sensitivity, which serve to efficiently wet substrates coated, and to disperse particulates, if any, employed in the formulated latex coating. Among the surfactants found to be useful in the practice of this invention, are amphoteric detergents, and certain organometallics based on tetravalent titanium or zirconium. These last have been found to contribute significantly to substrate adhesion and improved corrosion resistance on wood, metallic and ceramic substrates, and to be particularly useful in maximizing color intensities of carbon black, azo and phthalocyanine based pigments. Specific examples of the preferred types of hypersurfactants are given in Table C. These examples are intended to be illustrative rather than exhaustive of the scope of useful materials.

TABLE C
(CA) zirconium 4 tetrakis oleylolato adduct one mole of
bis(octyl)phosphite
(CB) zirconium 4 bis bis(2,4-dioxo)undecanolato
(CC) zirconium 4 isooctanolato tris p-[3-N(methyl)morpholino]octyl
phenyl phosphonic acid
(CD) zirconium 4 2-oxy propanoato,bis(mono phenyl ether)triethylene
glycolato
(CE) Titanium 4 octyl,[(tris octyl)diphosphato
(CF) zirconium 4 oxoethylene,bis (dodecyl)phenylsulfonato
(CG) oxy [bis zirconium 4(bis tridecyl)diphosphate]
(CH) zirconium 4 tetraethylene glycol monomethyl ether,tris(tetraethylene
glycol monomethyl ether)diphosphato
(CJ) 4-N-(methyl),N-octylamino,1,4-cyclohexadiene carboxylic acid
(CK) triethylene glycol diolato,bis [zirconium 4 tris(octyl)phosphato]

The low Tg coalescents which are useful in the application of this invention are those with a Tg below 15° C., those most preferable have a Tg below 10° C. The specific low Tg resin employed as a co-coalescent in any given formulation must be at least partially compatible with the latex resin(s) employed in film formation. In practice, said restriction requires that the low Tg latex employed preferably be stabilized via the same charge type as the film former, except that Low Tg nonionic latexes may be employed in conjunction with anionic, cationic and or nonionic film forming latex resins. Examples of Low Tg resins useful in the practice of this invention are legion; however, for the sake of brevity, only 10 representative samples are provided in Table D.

The substitution of functionally equivalent materials, e.g. of unsaturated analogous unsaturated amides, for a portion of the aforementioned unsaturated ethers, esters or ether-esters disclosed above, and/or halogenation of one or more of the species of components heretofore described as necessary to the successful practice of this invention is envisioned by this invention and such non-critical modifications, and/or combinations of relevant species types must be considered as within the scope of this disclosure.

TABLE D

(DA) Ethylene vinyl acetate¹
(DB) Poly vinyl acetate²
(DC) Ethylene acrylate copolymer³
(DD) Poly isoprene⁴
(DE) Poly vinyl butyral⁵
(DF) Vinyl acrylic copolymer⁶
(DG) Polychloroprene⁷
(DH) Vinyl alcohol, acetatecopolymer⁸
(DJ) Ethoxylated bisphenol A⁹
(DK) Chlorinated, chlorosulfonated polyethylene¹⁰
Notes:
¹Airflex 809 (Air Products);
²UCAR 371 (Dow);
³Acronol 2367 (BASF);
⁴IR401 Kraton Polymers;
⁵Butvar Dispersion BR (UCB/Soluta);
⁶Rhoplex 9100 (Rohm and Haas);
⁷Neoprene WR (Dupont-Dow Elastomers);
⁸Elvinil 51-05 Dupont Dow);
⁹Carbowax 2000 (Dow),
¹⁰Hypalon 40 (Dupont-Dow Elastomers).

An ink vehicle is a combination of components, other than pigments, which are collectively suitable for ink compositions. The ink vehicle can include any of the materials delineated herein, or can also include any standard ink vehicle component know in the art, including for example, solids, alkyds, polyesters or polyamides suitable for ink or printing compositions, and the like. A coloring agent, such as pigments, provides the desired color for the ink. The same material can be considered a varnish when pigments are absent from the composition. Varnishes are expressly considered one aspect of the compositions delineated herein.

The compositions herein are useful in flexographic printing applications. Such applications can be intaglio or off-set, including sheet-fed, cold-web, and heat set web printing.

The compounds of this invention (including as used in compositions herein) may contain one or more asymmetric centers and thus occur as racemates and racemic mixtures, single enantiomers, individual diastereomers and diastereomeric mixtures. E-, Z- and cis- trans-double bond isomers are envisioned as well. All such isomeric forms of these compounds are expressly included in the present invention. The compounds of this invention may also be represented in multiple tautomeric forms, in such instances, the invention expressly includes all tautomeric forms of the compounds described herein. All such isomeric forms of such compounds are expressly included in the present invention. All crystal forms of the compounds described herein are expressly included in the present invention.

The invention will be further described in the following examples. Further amplification of the scope and utility of the instant invention to latex coating applications in inks, paints and stains is illustrated by Examples 1 through 5. It should be understood that these examples are for illustrative purposes only and are not to be construed as limiting this invention in any manner. All references are expressly incorporated by reference in their entirety herein.

### EXAMPLES

### Example#1

This example illustrates the superiority of the present invention versus the prior art with respect to the productivity, VOC emissions, and performance quality in a masonry sealer application.

A masonry sealer formulation was prepared by the sequential dispersion of the indicated components (pigment dispersion times and grind quality achievement was noted). The resulting sealer was applied via roller to smooth surface, ten day old, 8″×18″×1″ thick concrete castings, at an application rate of one gallon per 1,500 square foot, dry time (to touch) was measured under conditions of 72° F. and 85% humidity. After 164 hours of drying @72° F. and 50% humidity; sealer performance was measured by , weighing the dry casting, then impounding a 6″ depth of water, or 6% salt solution on such a casting for twenty four hours, then draining and weighing the drained casting. The weight percent of water, and independently that of 6% salt solution, adsorbed by said castings were used to determine sealer efficacy. The results of this study are given in Table No. 1.

Formulation: in parts by weight; ( in order of addition) water 200.0; neutralizer¹, as shown; surfactant², as shown, biocides³, 18.50; hydroxy ethyl cellulose, 5.00; potassium tris polyphosphate, 2.00; defoamer⁴, 1.00; coalescent(s)⁵ and co coalescent resin(s)⁶, as shown; ultramarine blue pigment, 0.25; rutile titanium dioxide, 200.0, American process zinc oxide, 25; platy talc, 50; water, 50; Hg 54 Acrylic latex resin⁷, 352.0; defoamer⁴, 0.98; surfactant⁸, water, 24.99; and sodium nitrite 2.30, thixotrope⁹, 0.5-2.7 (as required), to adjust system viscosity to 85-90 KU at 75° F. The resulting formulations were drawn down @3 mils wet film thickness, on a black short oil melamine substrate, dried at ambient temperature and humidity for seven days, and the resultant emitted VOCs were determined by ASTM D3960. The dried coatings were evaluated for initial gloss¹⁰, and adhesion¹¹, followed by 4% saline immersion for 100 hours, at ambient, then dried for 48 hours at ambient, and reevaluated for gloss and adhesion. The formulations employed, and results of these tests are provided in Table 1.

TABLE 1

| | Formulation # | | | | | | | | | |
|---|---|---|---|---|---|---|---|---|---|---|
| | 1 | 2 | 3 | 4 | 5 | 6 | 7 | 8 | 9 | 10 |
| Coalescent(s) PBW | | | | | | | | | | |
| Propylene glycol | 60 | | | | | | | | | |
| Butoxy diglycol | 15 | | | | | | | | | |
| Propyl citrate | | 47 | | | | | | | | |
| Neopentyl glycol | | 41 | | | | | | | | |
| mono isobutyrate | | | | | | | | | | |
| Methyl iso amyl | 22 | | | | | | | | | |
| ketone | | | | | | | | | | |
| BA | | | 22 | | | | | | | 8 |
| BC | | | | 13 | | | | | | |
| BD | | | | | 11 | | | | | |
| BF | | | | | | 41 | | | 17 | |
| BK | | | | | | | | 18 | | 11 |
| Co-coalescent latex | | | | | | | | | | |
| Resin(s) PBW | | | | | | | | | | |
| DB | | | | 29 | | | | | | |
| DE | | | 45 | | | | | 34 | | |
| DF | | | | | 51 | | | | | |
| DG | | | | | | 13 | | | | 41 |
| DK | | | | | | | | 12 | 16 | |
| Neutralizer PBW | | | | | | | | | | |
| 28% ammonia aq. | 22 | | | | | | | | | |
| Tri ethyl amine | | 41 | | | | | | | | |
| Divinyl amine | | | 37 | | | | | | | |
| N,N-dimethylamino | | | | 13 | | | | | | |
| ethyl methacrylate | | | | | | | | | | |
| Dioctyl amine | | | | | 39 | | | | | |
| AA | | | | | | 16 | | | | |
| AC | | | | | | | 21 | | | |
| AD | | | | | | | | 25 | | 8 |
| AF | | | | | | | | | 20 | |
| AJ | | | | | | | | | | 9 |
| Surfactants PBW | | | | | | | | | | |
| Acetylenic glycol¹⁰ | 21 | | | | | | | | | |
| Silicone¹¹ | | 16 | | | | | | | | |
| Sodium dodecyl | | 32 | | | | | | | | |
| benzene sulfonate | | | | | | | | | | |
| Octyl, tri ethyl | | | 27 | | | | | | | |
| ammonium | | | | | | | | | | |
| hydroxide | | | | | | | | | | |
| CA | | | | 6 | | | | | | |
| CC | | | | | 8 | | | | 2 | |
| CD | | | | | | 3 | | | | |
| CG | | | | | | | 5 | | | |
| CJ | | | | | | | | 1 | 2 | 1 |
| VOCs g/kg solid | | | | | | | | | | |
| Film Properties | | | | | | | | | | |
| initial gloss | | | | | | | | | | |
| post immersion gloss | | | | | | | | | | |
| initial adhesion | | | | | | | | | | |
| post immersion gloss | | | | | | | | | | |

Notes:
¹As shown;
²A combination of 3.5 parts of Nuosept 95, and 15 parts of Nuocide 404D, - Huls Corp. were employed;
³Defo 806-102; - Ultra Inc.
⁴Hg 54, - Rohm and Haas Corp.;
⁴Rhevis CR, Rhevis Corp.
⁵via EPA Method 24GC;
⁶Rohm and Haas Corp.;
⁸Eastman Kodak Inc.
⁹Joncryl 142 SC Johnson),
¹⁰ASTM Method; D529;
¹¹ASTM Method 3359;
¹²ASTM Method 53-D523.

The efficacy of the coalescent systems of the instant art in producing a more environmentally resistant, acrylic latex based masonry sealer as compared to conventionally coalesced counterparts are demonstrated from the preceding data. VOC emissions reduction is likewise self evident.

### Example #2

This example illustrates the superiority of the present invention versus the prior art with respect to the productivity, VOC emissions, and performance quality in a direct to metal, maintenance coating application.

Direct to metal coatings, were prepared by the sequential dispersion of the indicated components (pigment dispersion times were noted). The resulting coating was spray applied to sandblasted smooth surface 24″×8″ carbon steel test panels, at application rate of one gallon per 250 square foot. After 120 hours of drying @72° F. and 85% humidity, edge sealing and scribing, the coatings' corrosion resistance performance were each measured by QUV cabinet exposure [cyclic exposure to UV radiation, 4% saline solution, and varying temperature (25°-80° C.)].

Formulation: in parts by weight; (in order of addition) water, 50.0; neutralizer, as shown; surfactant^{a}, as shown, biocide¹, 4.00; oxidized polyethylene wax, 4.00; (disperse wax) polyurethane thixotrope², as shown; defoamer³, 2.00; coalescent^{a}, as shown; ultramarine blue pigment, 0.25; rutile titanium dioxide, 125; zinc aluminate 150; Acrylic latex resin⁴, 64.0; (disperse particulates to Hegman 7.5+). Neutralizer, as shown acrylic latex resin⁴, 564.0; defoamer², 0.98; surfactant^{b}, coalescent^{b}, as shown; water, 16.00; and sodium nitrite 2.30. Thixotrope², ( as required) to adjust system viscosity to 80-85 KU at 75° F. The control coating required 3.7 hours to disperse to a Hegman grind gauge reading of 7+, whereas each of the instant art coatings achieved said fineness of grind in less than one half hour. The results of this study are given in Table No. 2

TABLE NO. 2

| | Formulation #2- | | | | | |
|---|---|---|---|---|---|---|
| | 1 | 2 | 3 | 4 | 5 | 6 |
| neutralizer | DMAMP- | 1A/4.00 | 1C/1.80 | 1E/2.20 | 1J/1.78 | |
| | 80⁵/12.5 | | | | | |
| surfactant(a) | Triton | 3D/1.80 | 3F/1.75 | 3C/1.55 | 3J/1.50 | |
| | CF10⁶/10.00 | | | | | |
| thixotrope² | 15.00 | 5.00 | 5.50 | 4.70 | 5.30 | |
| coalescent(a) | Dipropylene | 2B/12.0 | 2E/10.5 | 2K/8.25 | none | /34.60 |
| | glycol | | | | | |
| surfactant(b) | Triton | none | 3A/1.00 | Triton | none | |
| | CF10⁶/4.0 | | | | | |
| coalescent | PmPE⁷/44.60 | 2A/16.42 | 2A/12.60 | 2F/18.55 | 2H/34.702C/ | |
| (b) | | | | | 7.45 | |
| thixotrope² | 21.40 | 3.20 | 1.50 | 0.70 | 2.30 | |

| Formulation #2- | VOC g/l | Initial gloss | 60° gloss @ | 60° gloss @ | 60° gloss @ |
|---|---|---|---|---|---|
| . | . | @60 | 200 hr. QUV | 500 hr. QUV. | 1,000 hr. QUV |
| 1 | 232 | 82 | 76 | 31 | film destroyed |
| 2 | 9 | 91 | 87 | 82 | 76 |
| 3 | 11 | 93 | 90 | 88 | 80 |
| 4 | 8 | 87 | 86 | 87 | 84 |
| 5 | 6 | 90 | 84 | 80 | 66 |
| 6 | 10 | 86 | 85 | 84 | |

Notes:
¹Nuosept 95, - Huls Corp.;
²Acrysol RM 2020, - Rohm and Haas
³Defo 3000; - Ultra Inc.
⁴HG 56, - Rohm and Haas Corp.;
⁵80% 2-N,N-dimethylamino-2-methyl propanol aq.
⁶Union Carbide Corp.
⁷propylene glycol mono phenyl ether.
⁸via EPA Method 24GC
The efficacy of the coalescent systems of the instant art in producing a more environmentally resistant, acrylic latex based direct to metal coating, as compared to a conventionally coalesced counterpart, are demonstrated from the preceding data. VOC emissions reduction, and improvement in productivity achieved are likewise self evident.

### Example #3

This example illustrates the superiority of the present invention versus the prior art with respect to productivity, VOC emissions, and performance quality in a polyvinyl acetate based interior flat architectural paint application.

Interior flat paints, were prepared by the sequential dispersion of the indicated components (pigment dispersion times, and dispersion efficacy were noted). The resulting coating was brush applied to unprimed drywall (gypsum sheet) @72° F. and 80% humidity, coverage, stain removal, and scrubability performance were each measured after 7 days of drying 72+\2°@65-80% humidity.

Formulation: in parts by weight; ( in order of addition) water, 200.0; neutralizer¹, as shown; surfactant^{a}, as shown, biocides², 1.00; hydroxy ethyl cellulose, as shown; potassium tris polyphosphate, as shown; defoamer³, 1.00; coalescent^{a}, as shown; ultramarine blue pigment, 0.25; rutile titanium dioxide, 250.0, water washed clay⁴, 50.0; calcium carbonate⁵, as shown; diatomite⁶, 50.0; water, 49.98; PVA latex resin⁷, 352.0; defoamer², 0.98; coalescent^{b}, as shown; water, 100.0; and sodium nitrite 2.30; thixotrope⁸, as shown (required) to adjust system viscosity to 90-100 KU at 75° F .

The results of this evaluation are shown in Table No. 3.

TABLE NO. 3

| | Formulation #3- | | | | |
|---|---|---|---|---|---|
| | 1 | 2 | 3 | 4 | 5 |
| neutralizer | 28% ammonia aq. | 1B/2.00 | 1H/1.80 | 1G/2.20 | 1D/1.78 |
| HEC(QP-4400) | 5.50 | 1.20 | 1.35 | 1.25 | 1.40 |
| surfactant(a) | Tamol 731/6.90 | 3E/1.80 | 3J/1.75 | 3C/1.55 | 3F/1.50 |
| . | Triton N101/3.31 | | | | |
| coalescent(a) | Propylene glycol/ | 2A/6.00 | 2F/7.00 | 2H/5.50 | 2E/7.00 |
| . | 51.95 | | | | |
| . | Texanol/9.88 | | | | |
| Calcite | 50 | 150 | 125 | 150 | 140 |
| coalescent (b) | 2A/26.4 | 2C/12.60 | 2F/18.50 | 2J/11.90 | |
| thixotrope⁸ | 3.5 | 3.0 | 3.1 | 2.7 | 2.4 |

| | | Dispersion | | min. | | |
|---|---|---|---|---|---|---|
| Formulation | VOC g/l⁹ | time | Grind | coalescence | Scrubs¹⁰ | Stain |
| . | . | HR. | Hegman | temp° C. | . | removal¹¹#3- |
| 1 | 199 | 2.4 | 4 | 57 | 410 | 7 |
| 2 | 8 | 0.4 | 5 | 34 | 1,740 | 9 |
| 3 | 3 | 0.6 | 6 | 32 | 2,025 | 10 |
| 4 | 5 | 0.6 | 6 | 36 | 1,960 | 9 |
| 5 | 4 | 0.5 | 5 | 30 | 2,230 | 10 |

Notes:
¹As shown;
²Nuosept 95, , - Huls Corp.;
³Defo 3000; - Ultra Inc..
⁴70C Huber Corp.
⁵Camel Carb., Cambel Corp.;
⁶Diafil 530 Whittaker, Clark, and Danials Inc.
⁷Rhoplex 3077, Rohm and Haas Corp.;
⁸Rhevis CR, Rhevis Corp.
⁹via EPA Method 24GC.
¹⁰ASTM method;
¹¹ASTM method.

The efficacy of the coalescent systems of the instant art in producing a more, scrub and stain resistant PVA latex based interior flat architectural coating as compared to a conventionally coalesced counterpart are demonstrated from the preceding data. VOC emissions reduction and improvement in both productivity and dispersion level achieved are likewise self evident, as is a considerable reduction in minimum coalescence temperature, without recourse to the use of low boiling, flammable solvent(s), normally employed to induce same.

### Example #4

This example illustrates the superiority of the present invention versus the prior art with respect to the productivity, VOC emissions, and performance quality in a force dried, clear, protective, two component acrylic latex cured—waterborne epoxy, wood cabinet coating.

Component A: neutralizing agent, as shown-3.5 PBW; sodium nitrite 0. 15 and defoamer (Patcote 519—Patco Coatings Inc.) were admixed with 95.85 PBW of (Acrylic latex—Maincote AE 58 ), and said emulsion was subsequently mixed with 50 PBW of Component B, formulated by blending various additives, as shown into 12.5 PBW of Genepoxy 370-H55-Daubert Chemical Co., and diluting as necessary with water to produce a total part B weight of 25 parts. thixatrope¹ was added, as required, to provide an initial mix viscosity of 65-70 KU, and the coating was applied by curtain coating on sanded but unprimed 4′×8′×0.25″ laminate natural oak (on pine) substrate. The coated panels were force dried by passing same through a 180° F. oven for 20 minutes, then cooled at ambient temperature (ca. 80° F.) for 24 hours prior to evaluation, for abrasion and solvent resistance. to determine coating performance efficacy. The results of this study are given in Table No. 4.

TABLE NO. 4

| | Formulation#4- | | | | | | |
|---|---|---|---|---|---|---|---|
| | 1 | 2 | 3 | 4 | 5 | 6 | 7 |
| Part A: | | | | | | | |
| neutralizer | 28% | 1A | 1H | 1H | 1H | 1B | ammonia aq. |
| Part B: formulation | | | | | | | |
| Texanol | | 8.00 | | | | | |
| diethylene glycol mono | 18.20 | | | | | | |
| butyl ether | | | | | | | |
| 2A | | | .12.05 | | | | |
| 2C | | | | .6.00 | 10.50 | | |
| 2B | | | | | | | 8.40 |
| 2H | 4.35 | | | | | | |
| 2G | 10.50 | 1.90 | | | | | |
| 2J | | | | 2.10 | | | |
| 3H | 2.00 | 2.00 | 2.00 | 2.00 | 2.00 | | |

| | | Abrasion | Solvent | Stain | Mix pot life |
|---|---|---|---|---|---|
| Formulation #4- | VOC g/l¹ | resistance² | resistance³ | resistance⁴ | hr. @ 80° F.⁵ |
| 1 | 165 | 114 | lifts | poor | 7.5 |
| 2 | 3 | 31 | slight softening | good | 42 |
| 3 | 4 | 89 | mod. softening | Fair | 35 |
| 4 | 3 | 24 | no change | excellent | 40 |
| 5 | 3 | 98 | severe | Fair | 61 |
| | | | softening | | |
| 6 | 4 | 73 | mod. Softening | Fair | 46 |
| 7 | 3 | 19 | no change | good | 37 |

Notes:
¹By EPA Method 24GC; (formulations 2 through 7 produced 0 to negative VOC readings by EPA Methods 24, and 24A;
²Tabor CS-10 wheel 1000 cycles;
³24 hr methyl ethyl ketone covered spot test;
⁴24 hr exposure to lipstick;
⁵time to 10% 5 loss of abrasion resistance in finished coating.

This example demonstrates that the use of the combination of components cited as the basis of the instant invention, viz. That nonvolatile reactive amines, in combination with hydroxyl bearing unsaturated esters/ethers/ether-esters, as (partial or full) replacements for conventionally employed volatile amines/ammonia neutralizers, and organic solvents as coalescents, respectively may be employed to substantially enhance the processability ( pot life), mechanical and chemical resistance properties ( abrasion and stain resistance respectfully) as well as attain VOC reduction in wood coatings.

A further benefit of the instant invention as applied to wood coatings is that unlike conventionally coalesced waterborne coatings, e.g. formulation 4-1; latex formulations based upon the teachings of this invention, e.g., formulations 4-2 through 4-7, do not cause significant grain rise, thereby virtually eliminating the necessity for intercoat sanding. These data also demonstrate that subsets of the preferred combination of components herein disclosed ( e.g. formulations 4-3,4-5, and 4-6) may provide considerable benefits relative to their conventional counterparts; however, omission of one or more of the components of the combination herein disclosed leads to inferior results as compared to the inclusion of the full compliment.

### Example #5

This example illustrates the superiority of the present invention versus the prior art with respect to the productivity, VOC emissions, and performance quality in waterborne flexographic inks.

A latex flexo. ink formulation, was prepared by the sequential dispersion of the indicated components ( pigment dispersion times and grind quality achievement was noted). The resulting ink was applied via a #6 wire wound rod to bond paper, and permitted to dry. Dry time (to touch) was measured under conditions of 72° F. and 85% humidity. After 6 hours of drying @72° F. and 85% humidity, heat seal resistance performance (face to face) was measured at 25 psig. and 2 seconds contact time) the results of this study are given in Table No. 5.

Formulation: in parts by weight; ( in order of addition) E-2350 resin 267; neutralizer, as shown; surfactant, as shown; Defo 1020 defoamer 4.00 Ultra Inc.; coalescent^{a}, as shown; calcium lithol pigment 50% presscake, 400-Sun Chemical Corp.; Michemlube wax 5-Michelman Inc,. water, as required in order to produce a viscosity of 27 seconds using a #2 Zahn cup. Relative dry ink color intensities were measured by integrating thin film reflectance spectra at 300-600 um wavelengths using a spectrophotometer after 48 hours of drying at the above conditions

TABLE NO. 5

| | Formulation # | | | | |
|---|---|---|---|---|---|
| | 1 | 2 | 3 | 4 | 5 |
| neutralizer | 28% ammonia aq, | 1D/2.00 | 1H/1.40 | 1F/2.00 | 1D/1.46 |
| | 2.00 | | | | |
| surfactant | Tamol 850/4.95 | 3A/1.80 | 3E/1.75 | 3K/1.55 | 3H/1.50 |
| coalescent | isopropanol | 2A/30.5 | 2E/10.0 | 2C/25.0 | 2C/30.0 |
| | 130 | 2C/15.5 | 2H/7.0 | 24H/5.5 | |

| Formulation | | | | |
|---|---|---|---|---|
| # | VOC g/l⁵ | Dry to touch | 6 hr. Heat seal | Relative color |
| . | . | time hr. | resistance ° C. | intensity |
| 1 | 144 | 3.4 | 86 | 1.00 |
| 2 | 4 | 0.7 | 154 | 1.42 |
| 3 | 3 | 0.6 | 172 | 1.27 |
| 4 | 5 | 0.7 | 104 | 1.08 |
| 5 | 4 | 0.6 | 167 | 1.39 |

Notes:
The efficacy of the coalescent systems of the instant art in producing a faster drying, more strongly colored, and lower VOC acrylic latex based printing ink coating as compared to a conventionally coalesced counterpart are demonstrated from the preceding data, as are indications that incomplete application of the teachings of this disclosure may lead to inferior results. Note the deficiencies in the performance of formulation 5-4 as compared to 5-2, 5-3, and 5-5.

Although methods and materials similar or equivalent to those described herein can be used in the practice or testing of the present invention, suitable methods and materials are described below. In addition, the materials, methods, and examples are illustrative only and not intended to be limiting.

A number of embodiments of the invention have been described. Nevertheless, it will be understood that various modifications may be made without departing from the spirit and scope of the invention. Accordingly, other embodiments are within the scope of the following claims.

1. A composition comprising (essentially consisting of) a combination of essentially nonvolatile, unsaturated esters/ethers/ether-esters, and a low glass transition temperature (Tg) latex resin.

2. The composition of claim 1, further comprising a nonvolatile reactive amine.

3. The composition of claim 1 or 2, further comprising a organometallic.

4. The composition of claim 1, wherein the composition is a latex coating, ink or paint.

5. The composition of any of claims 1-4, wherein the coalescent comprises (consists essentially of) the combination of essentially nonvolatile, unsaturated esters/ethers/ether-esters, and a low glass transition temperature (Tg) latex resin.

6. The composition of claim 5, wherein the coalescent further comprises (consists essentially of) a nonvolatile reactive amine.

7. The composition of claim 5, wherein the coalescent further comprises (consists essentially of) an organometallic.

8. The composition of claim 5, wherein the coalescent further comprises (consists essentially of) a nonvolatile reactive amine and a organometallic.

9. The composition of any of claims 1-9, wherein the composition is essentially devoid of conventional surfactants.

10. A coalescent system for latex resins comprising a combination of essentially nonvolatile, unsaturated esters/ethers/ether-esters, and low Tg latex resins.

11. The composition of any of claims 1-10, wherein the unsaturated esters/ethers/ether-esters comprise one or more hydroxyl functional groups.

12. A coalescent system for acrylic latex resins comprising a combination of essentially nonvolatile, unsaturated esters/ethers/ether-esters, and low Tg latex resin(s), and optionally from 0.2 to about 2 weight % of one or more organometallic based surfactants, and optionally from 0.1 to about 4% of essentially non-volatile reactive amine(s).

13. A coalescent system for vinyl, and or vinyl copolymer latex resins comprising a combination of from 1 to 15% essentially nonvolatile, unsaturated esters/ethers/ether-esters, and from 1 to 15% of low Tg latex resin(s), and optionally from 0.1 to about 2 weight % of one or more metallic based surfactants, and optionally from 0.1 to about 4% of essentially non-volatile reactive amine(s).

14. A coalescent system for styrenic copolymer latex resins comprising a combination of essentially nonvolatile, unsaturated esters/ethers/ether-esters, and low Tg latex resin(s), and optionally from 0.1 to about 2 weight % of one or more metallic based surfactants, and optionally from 0.1 to about 4% of essentially non-volatile reactive amine(s).

15. A coalescent system for polyurethane latex resins comprising a combination of essentially nonvolatile, unsaturated esters/ethers/ether-esters, and low Tg latex resin(s), and optionally from 0.1 to about 2 weight % of one or more metallic based surfactants, and optionally from 0.1 to about 4% of essentially non-volatile reactive amine(s).

16. A coalescent system for polyester latex resins comprising a combination of essentially nonvolatile, unsaturated esters/ethers/ether-esters, and low Tg latex resin(s), and optionally from 0.1 to about 2 weight % of one or more metallic based surfactants, and optionally from 0.1 to about 4% of essentially non-volatile reactive amine(s).

17. A method for coalescing a latex resin comprising combining a latex resin with an essentially nonvolatile unsaturated ester/ether/ether-ester and a low Tg latex resin.

18. The method of claim 17, further comprising combining from 0.2 to about 2 weight % of one or more organometallic based surfactants.

19. The method of claim 17, further comprising combining from 0.1 to about 4 weight % of essentially non-volatile reactive amine(s).

20. The method of claim 18, further comprising combining from 0.1 to about 4 weight % of essentially non-volatile reactive amine(s).

21. The method of any of claims 17-20, wherein the latex resin is a vinyl copolymer.

22. The method of any of claims 17-20, wherein the latex resin is a styrenic copolymer.

23. The method of. any of claims 17-20, wherein the latex resin is an acrylic polymer or copolymer.

24. A method of making any one of a low VOC latex coating, paint, or ink, comprising combining a latex resin with an essentially nonvolatile, unsaturated ester/ether/ether-ester and low Tg latex resin(s).

25. The method of claim 24, further comprising combining from 0.2 to about 2 weight % of one or more zirconium based surfactants and/or from 0.1 to about 4 weight % of essentially non-volatile reactive amine(s).

26. The method of claim 24 or 25, wherein the latex coating, paint, or ink is essentially devoid of VOCs.

27. A product made by the process of combining essentially nonvolatile, unsaturated esters/ethers/ether-esters, and low Tg latex resin(s), and optionally from 0.1 to about 2 weight % of one or more organometallic based surfactants, and optionally from 0.1 to about 4% of essentially non-volatile reactive amine(s).

28. A method of making a low VOC latex coating, useful as floor coating, architectural and/or maintenance coatings, comprising combining a latex resin with an essentially nonvolatile, unsaturated ester/ether/ether-ester and low Tg latex resin(s).

29. A method of making a low VOC latex coating, useful as a floor coating, architectural and/or maintenance coatings, comprising combining a latex resin with an essentially nonvolatile, unsaturated ester/ether/ether-ester and low Tg latex resin(s)wherein the coalescent further comprises a nonvolatile reactive amine, and optionally, an organometallic, and/or a polyglycol mono ether, and or polyglycol mono ether ester, preferably a polyglycol mono ether ester having an hydroxyl group alpha or beta to the ester carboxyl.

30. A low VOC latex coating, useful as a floor coating, architectural and/or maintenance coatings, comprising a latex resin with an essentially nonvolatile, unsaturated ester/ether/ether-ester and low Tg latex resin(s) as a coalescent, wherein the coalescent further comprises a nonvolatile reactive amine, and optionally, an organometallic, and/or a polyglycol mono ether, and or polyglycol mono ether ester, preferably a polyglycol mono ether ester having an hydroxyl group alpha or beta to the ester carboxyl.
